(19) United States
(12) Patent Application Publication
(10) Pub. No.: US 2016/0381203 A1
(43) Pub. Date: Dec. 29, 2016

(54) AUTOMATIC TRANSFORMATION TO GENERATE A PHONE-BASED VISUALIZATION

(71) Applicant: Microsoft Technology Licensing, LLC, Redmond, WA (US)

(72) Inventors: Jacob Winther Jespersen, Frederiksberg (DK); Michael Helligsø Svinth, Taastrup (DK); Vincent Francois Nicolas, Vaerloese (DK); Mike Borg Cardona, Skodsborg (DK)

(21) Appl. No.: 14/747,605

(22) Filed: Jun. 23, 2015

(51) Int. Cl. H04M 1/725; H04W 4/18

(52) U.S. Cl. CPC H04M 1/72561; H04W 4/18; H04M 1/72583

(57) ABSTRACT

The constituent elements of a user interface display for an application are identified from visualization metadata and transformed into a mobile device visualization. the visualization is surfaced for user interaction, and actions are performed based on any detected user interactions with the surfaced visualization.

### BACKGROUND

Computing systems are currently in wide use. Some such computing systems include applications that can be accessed by different form factor client devices. For instance, some applications can be accessed by both tablet computing devices and phone computing devices. These types of devices can often have a vastly different amount of display real estate, because the hardware display device on which information is visually surfaced, for each of the devices, is a different size.

This can result in an application developer developing two different sets of code. One set will be suitable to run and surface visualizations on a tablet computing device, while the other is suitable to run and generate surface visualizations on a phone computing device. In some scenarios, the developer may develop an application for running on a tablet computing device, and then apply some type of process to derive a phone representation of the user interface displays that already exist for the tablet device. These types of processes can be manual and often involve heuristics that rely on human judgement to carry out. Manual processes of this type are often infeasible (or are very difficult) to perform because of the cost multiplication that comes with each new or changed user interface display.

Some types of automated conversion processes have been attempted as well. One type of automated conversion is known as scaling. To perform scaling, the structural organization of a presentation remains intact. When it is displayed on a smaller screen device, the user experiences a zooming effect. However, for text and many interactive controls in a user interface display, simple scaling conversions can provide an undesirable user experience.

Another type of automated conversion rearranges the structural organization of the contents of a tablet user interface display. The individual elements of the user interface presentation thus shift position relative to each other in a specific way when displayed on a phone. The resulting user experience on the phone is divided up, either spatially, in time, or both, as compared to the user experience on the tablet device. Some of these types of conversions are based on HTML5/CSS3 technologies. These conversions can have a degrading effect on the resulting phone user interface display, in that they may not adequately take into account the characteristics of the content displayed on the tablet display.

The discussion above is merely provided for general background information and is not intended to be used as an aid in determining the scope of the claimed subject matter.

### SUMMARY

The constituent elements of a user interface display for an application are identified from visualization metadata and transformed into a mobile device visualization. the visualization is surfaced for user interaction, and actions are performed based on any detected user interactions with the surfaced visualization.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a computing system architecture.

FIG. 2 is a flow diagram illustrating one example of the operation of the visualization system shown in the architecture of FIG. 1.

FIG. 2A is a diagrammatic view of a transformation of a tablet user interface display to a phone user interface display.

FIGS. 2B-2C are examples of user interface displays.

FIG. 3 is a flow diagram showing one example of the operation of the visualization system shown in FIG. 1 in generating a list page visualization.

FIG. 3A is a diagrammatic view illustrating a transformation of a tablet user interface list view display to a phone user interface list view display.

FIGS. 3B-3F show examples of user interface displays.

FIG. 4 is a flow diagram illustrating one example of the operation of the visualization system shown in FIG. 1 in generating a details page display.

FIGS. 4A and 4A-1 (collectively FIG. 4A) show a diagrammatic view illustrating the transformation of a details page view user interface display on a tablet device to a details page user interface display on a phone.

FIGS. 4B-4E show examples of user interface displays.

FIG. 5 is a block diagram of one example of the architecture illustrated in FIG. 1, deployed in a cloud computing architecture.

FIG. 6 is a block diagram of one example of a mobile device.

FIG. 7 is one example of a tablet computing device.

FIG. 8 is one example of of a smart phone.

FIG. 9 is a block diagram of one example of a computing environment that can be deployed in the architectures shown in the previous figures.

### DETAILED DESCRIPTION

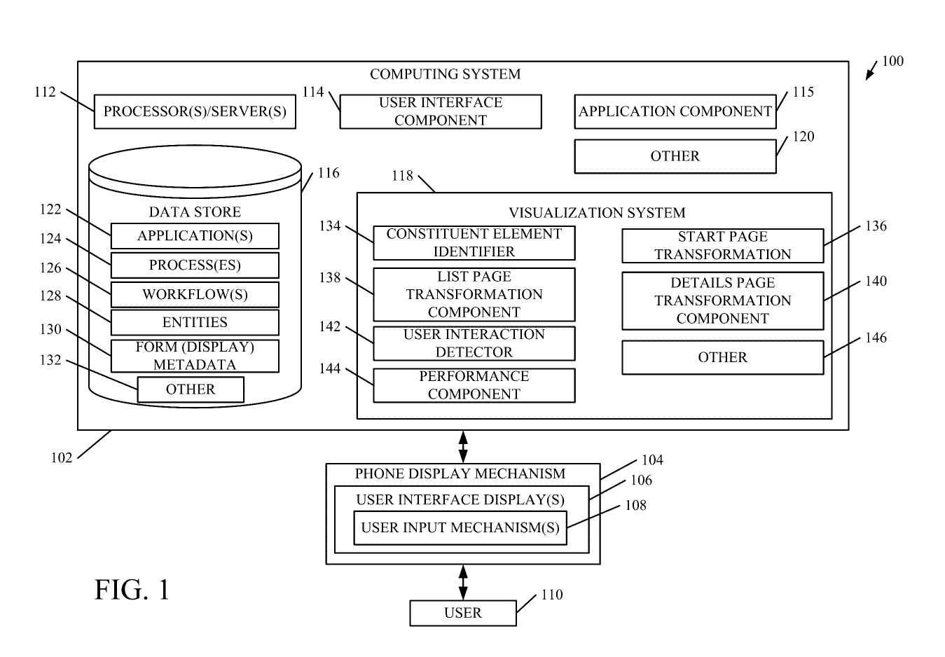

FIG. 1 is a block diagram of one example of a computing system architecture 100. Architecture 100 shows computing system 102 interacting with phone display mechanism 104. In the example shown in FIG. 1, it will be appreciated that computing system 102 and display mechanism 104 can be on the same phone computing system. In another example, various functionality described with respect to FIG. 1 can be split among a variety of different computing systems, but the phone display mechanism 104 is illustratively a display screen on a phone computing device.

Computing system 102 illustratively generates user interface displays 106, with user input mechanisms 108, on phone display mechanism 104, for interaction by user 110. User 110 illustratively interacts with user input mechanisms 108 in order to control and manipulate computing system 102.

In the example shown in FIG. 1, computing system 102 illustratively includes one or more servers or processors 112, user interface component 114, application component 115, data store 116, visualization system 118, and it can include a wide variety of other things 120 as well. Data store 116 can include applications 122, processes 124, workflows 126, entities 128, metadata 130 that defines forms (or user interface displays), and it can include other items 132. Visualization system 118 illustratively includes constituent element identifier 134, start page transformation component 136, list page transformation component 138, details page transformation component 140, user interaction detector 142, performance component 144, and it can include other items 146.

Before describing the overall operation of architecture 100 (and specifically visualization system 118) in more detail, a brief overview will first be provided. Application component 115 illustratively runs applications 122 to perform processes 124 or workflows 126. In doing so, it can use form metadata 130 to surface data for user 110 on phone display mechanism 104. It can also operate on entities 128 or any other data records.

Visualization system 118 illustratively accesses form metadata 130 that defines a user interface display that the user 110 wishes to have surfaced. Constituent element identifier 134 identifies the constituent elements of the display and then the other items in visualization system 118 transform those constituent elements into a phone display for surfacing on phone display mechanism 104. If the user interface display is of a start page, then start page transformation component 136 transforms the constituent elements of the start page to the phone visualization. If it is a list page, then list page transformation component 138 transforms the constituent elements into the phone visualization. If it is a details page, then details page transformation component 140 transforms the constituent elements of the details page into the phone visualization. Each component implements a set of transformation rules to transform the form, as defined by the form metadata (which may define the form for a tablet or other display device, or may define the form in a device-independent way) into a phone display on mechanism 104. User interaction detector 142 detects user interactions with the visualization (such as by actuating a button, link, scroll bar, etc.), and performance component 144 performs actions based upon those detected user interactions.

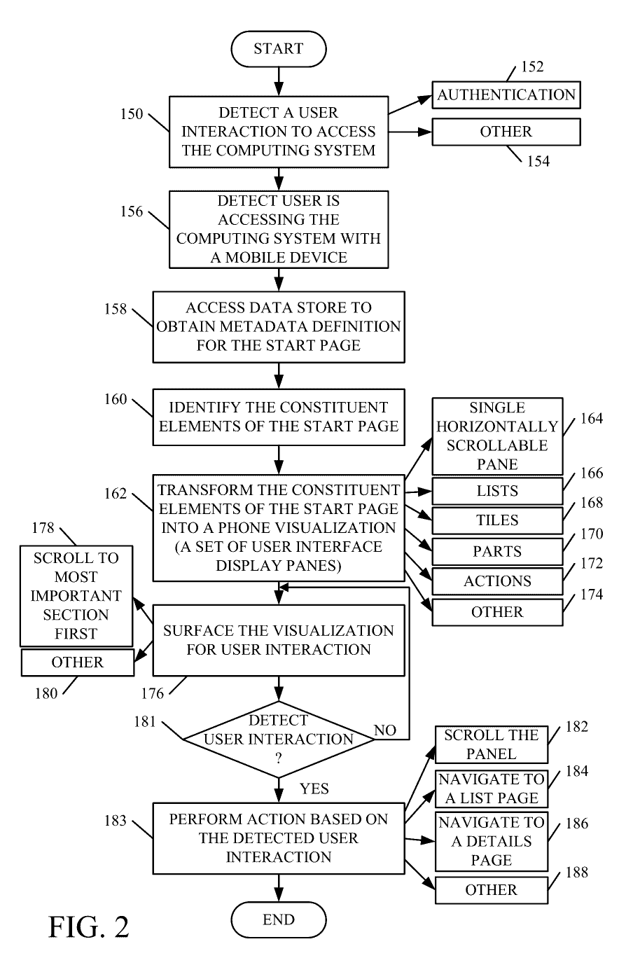

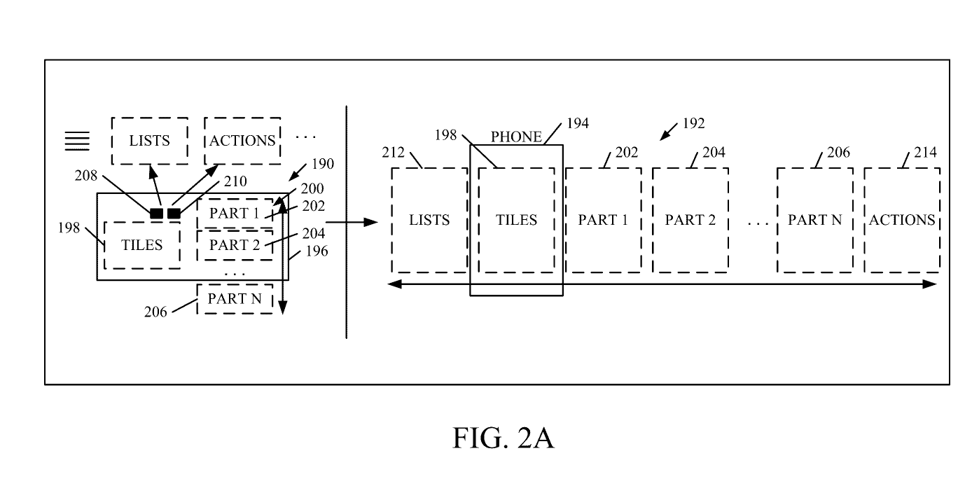

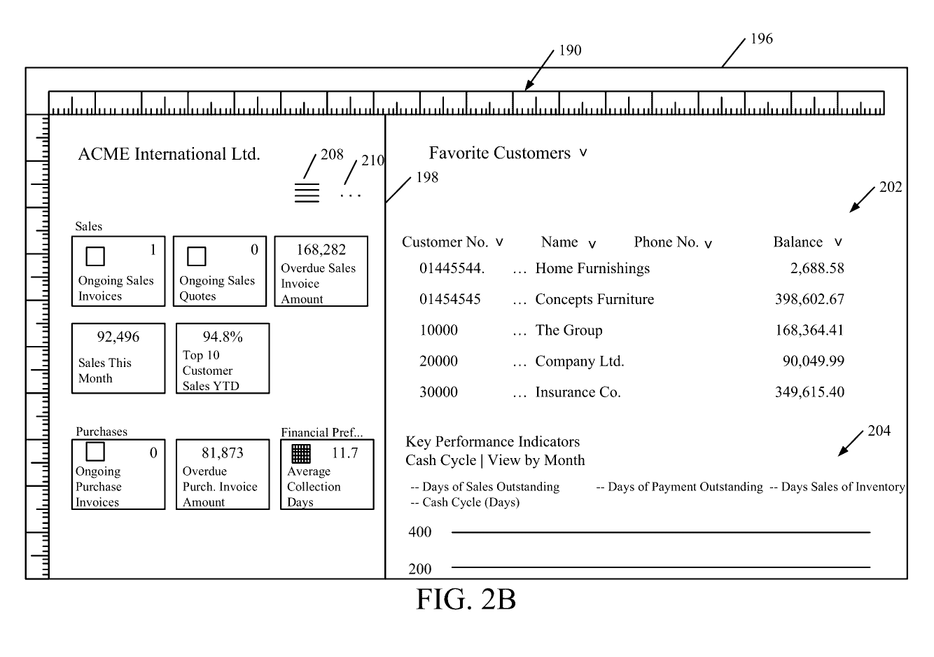

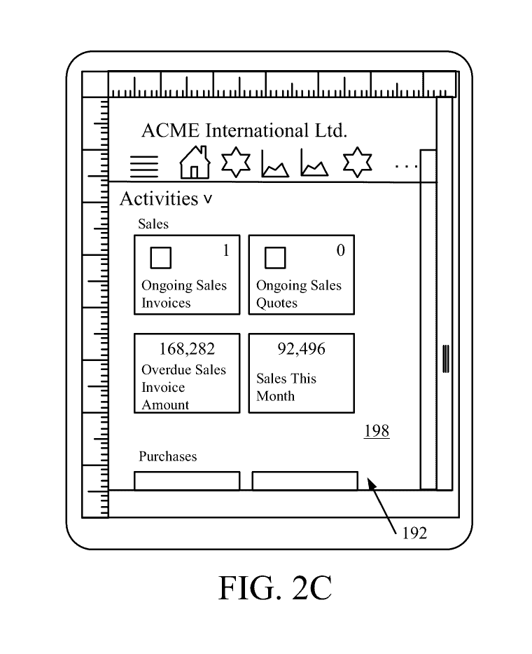

FIG. 2 is a flow diagram illustrating one example of the operation of visualization system 118 in generating a start page visualization for surfacing on phone display mechanism 104. In one example, computing system 102 first detects a user interaction to access the computing system 102, itself. This is indicated by block 150 in FIG. 2. For instance, user 110 may provide authentication information 152, or interact in other ways 154 to access computing system 102.

Computing system 102 then detects that user 110 is accessing the computing system 102 with a phone device. This can be done by querying the device or by viewing the device identity, itself, in other ways. This is indicated by block 156. Visualization system 118 then accesses data store 116 to obtain a metadata definition 130 for the start page of a given application 122 that the user is using. Accessing the start page metadata definition is indicated by block 158 in FIG. 2.

From that metadata, constituent element identifier 134 identifies the constituent elements on the start page user interface display. This is indicated by block 160. Start page transformation component 136 then transforms those constituent elements into a mobile device visualization (or a set of user interface display panes) that can be displayed on a mobile device. This is indicated by block 162. In one example, the transformation component 136 generates a single, horizontally scrollable panel as indicated by block 164. The panel can include a list section 166, a tiles section 168, a parts section 170, an actions menu section 172, and it can include a wide variety of sections 174.

Visualization system 118 then controls user interface component 114 to surface the visualization for user interaction. This is indicated by block 176. In doing so, it can automatically scroll the horizontally scrollable panel to a most important section, or a preferred section, or an otherwise pre-defined section. This is indicated by block 178. It can automatically scroll the scrollable panel to another section as well, as indicated by block 180.

User interaction detector 142 then detects any user interactions with actuatable elements on the user interface display. This is indicated by block 181. Performance component 144 then performs actions based on the detected user interaction. This is indicated by block 183. The actions can include a wide variety of different actions. For instance, the user may provide a scroll input in which case performance component 144 scrolls the panel. This is indicated by block 182. The user may interact with a navigation element that navigates the user to a list page display. This is indicated by block 184. The user may perform a sequence of interactions that navigates the user to a details page display, as indicated by block 186. The user can perform a wide variety of other interactions as well, that result in the performance of other actions. This is indicated by block 188.

FIG. 2A is a diagrammatic representation of the transformation of a tablet user interface display 190 into a phone user interface display 192. The phone display mechanism is represented at 194, and a tablet display mechanism (e.g., display screen) is represented by 196. In one example, the tablet user interface display 190 is pre-defined in data store 116. It has constituent elements (defined by metadata 130) that include a tiles section 198 that displays dynamic tiles. It can have a scrollable parts section 200 that displays elements 202-206, each corresponding to a display part. It can also have display elements 208 and 210 that correspond to lists and actions, respectively. For instance, if the user actuates list actuator 208, a pop-up pane showing user actuatable elements can be displayed. If the user actuates one of the elements on the pop-up pane, the user is navigated to a corresponding list view. The actions mechanism 210 can also be a pop-up pane so that if the user actuates it, a pop-up menu of user actuatable elements is displayed. Each of those elements may correspond to an action that can be performed.

Start page transformation component 136 transforms the display 190 so that the constituent elements are displayed in phone display 192. In the example shown in FIG. 2A, the content of the list pop-up pane can be displayed on a list section 212. The dynamic tiles section 198 can be displayed as well. The part display sections 202-206 can be displayed in a horizontally scrollable panel. The contents of the actions pop-up pane can also be displayed in a separate section 214.

FIG. 2A illustrates that, when the start page is first displayed on phone display mechanism 194, visualization system 118 automatically scrolls the scrollable panel that comprises display 192 to show the tiles section 198 on the phone display mechanism 194. Therefore, if the user scrolls to the left, the user can see the list items that can be actuated to navigate to list views. If the user scrolls to the right, the user can see the various parts 202-206 and eventually see the actions display section 214 where the user can actuate a user input mechanism to take a corresponding action. In one example, a table of contents actuator can be provided so the user can navigate to different sections of display 192 directly without scrolling.

FIG. 2B shows one example of the tablet user interface display 190 of a start page. Some of the items on table display 190 are similar to those shown in FIG. 2A and are similarly numbered. It can be seen that tiles section 198 shows a plurality of different dynamic tiles. The lists and actions user input mechanisms 208 and 210, are shown as well. The various parts 202, 204, etc. are shown in a vertically scrollable panel.

FIG. 2C shows the tiles display portion 198 of the phone user interface display 192. Some of the items on phone display 192 are similar to those shown in FIG. 2A and are similarly numbered. It can be seen that the visualization system 118 has automatically scrolled the display to show the tiles display portion 198. Of course, if the user scrolls to the left or the right, the user can view the other display sections shown in FIG. 2A, corresponding to the start page display.

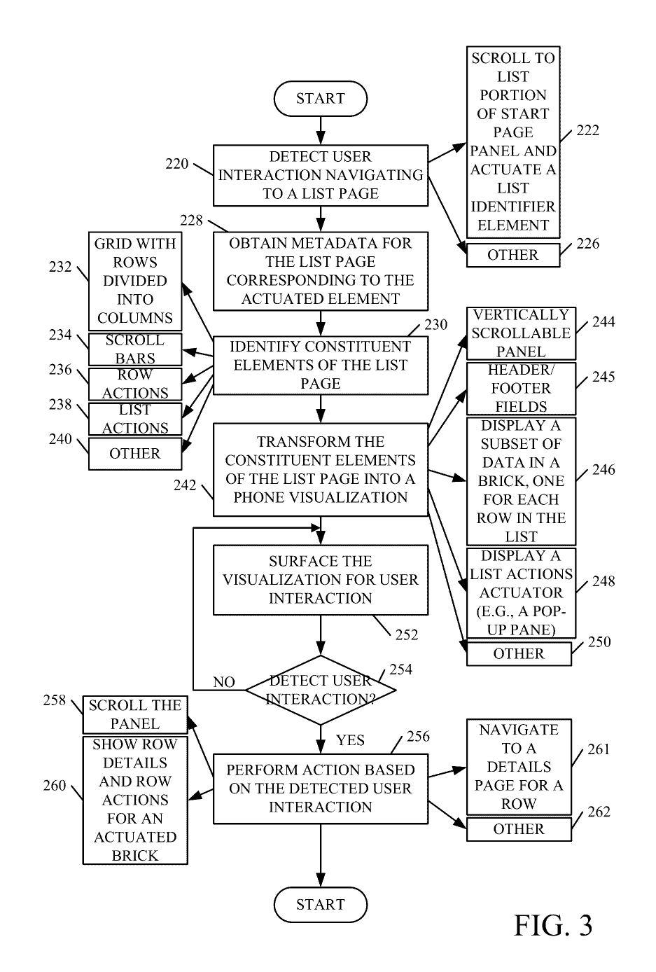

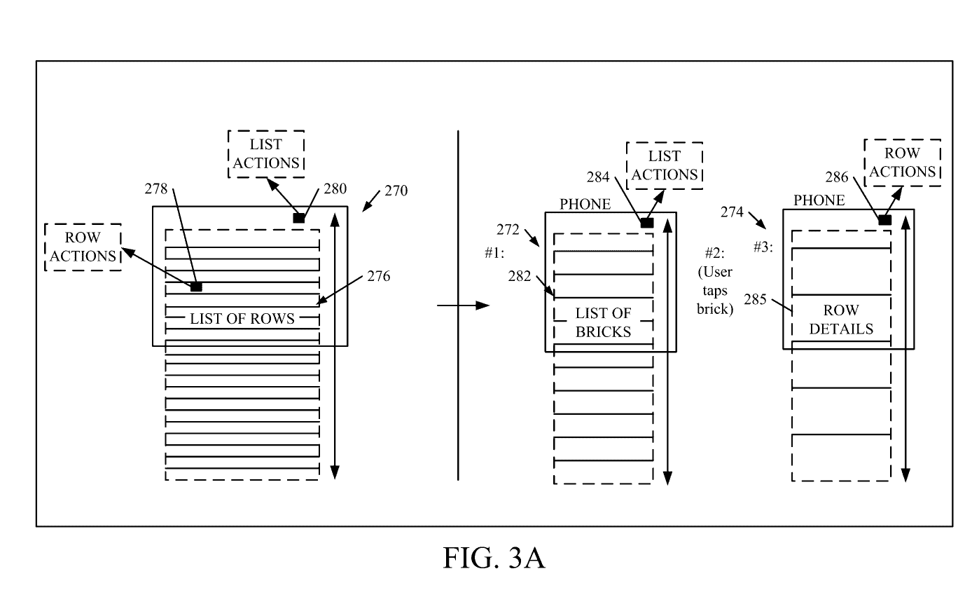

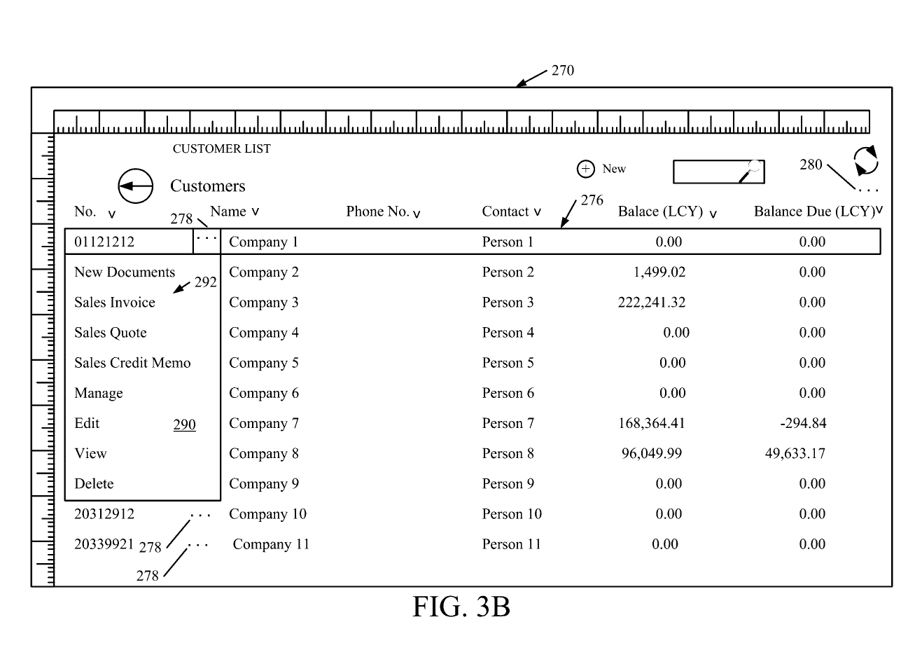

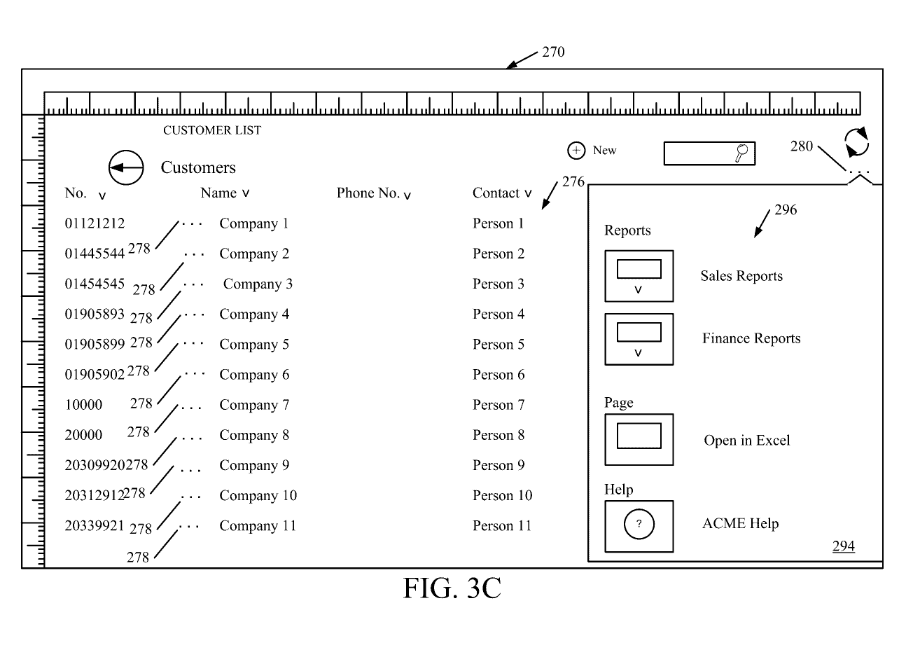

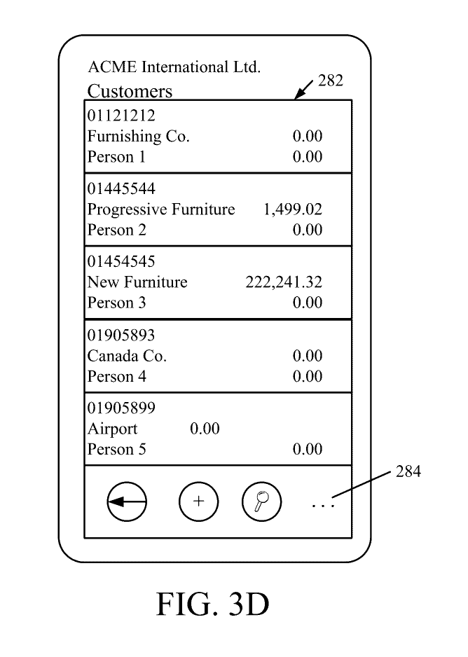

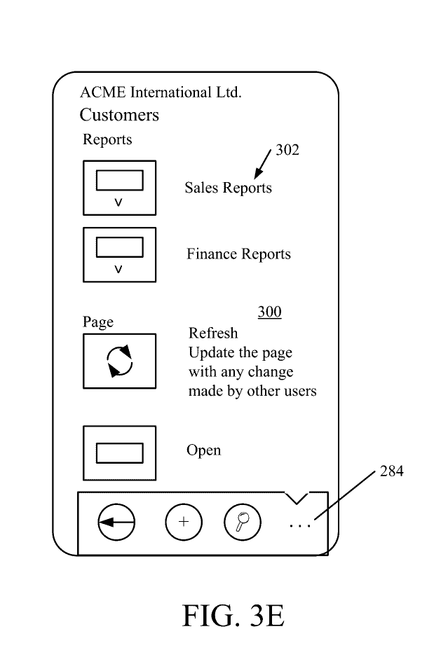

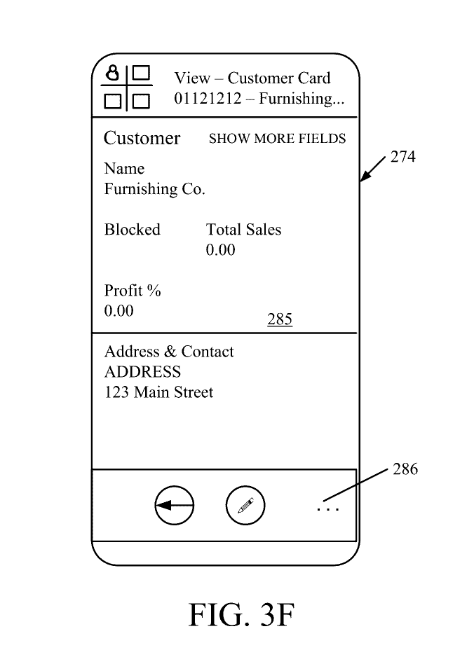

FIG. 3 is a flow diagram illustrating one example of the operation of list page transformation component 138 in generating a list page user interface display on the phone display mechanism 104. User interaction detector 142 first detects a user interaction indicating that the user has navigated to a list page. This is indicated by block 220 in FIG. 3. For instance, it may be that the user has scrolled to the list display portion 212 on display 192 and actuated a list element to navigate to a list page display. This is indicated by block 222. The user may have navigated to a list page display in other ways as well, and this is indicated by block 226.

Visualization system 118 then obtains metadata 130 for the list page corresponding to the actuated element. This is indicated by block 228 in FIG. 3. Constituent element identifier 234 then identifies constituent elements of the list page, from the metadata. This is indicated by block 230 in FIG. 3. The constituent elements may be, for instance, a grid structure with rows divided into columns, as indicated by block 232. It can include scroll bars 234, row action actuators 236, list action actuators 238, or a variety of other things 240.

List page transformation component 138 transforms the constituent elements of the list page into a mobile device visualization. This is indicated by block 242. In one example, for instance, it converts a set of the constituent elements into a vertically scrollable panel. This is indicated by block 244. The visualization can also include header and footer fields at the top and bottom, respectively, of the vertically scrollable panel. This is indicated by block 245. The vertically scrollable panel can display a set of “bricks”. Each “brick” illustratively corresponds to one row in the list for which the list page is being generated. It illustratively displays a subset of the data from the row in the underlying list. In one example, it includes the specific data that identifies the row sufficiently to the user. Displaying a subset of data in a “brick” is indicated by block 246 in FIG. 3.

In one example, the visualization also displays a list actions actuator. The list actions actuator can be activated to show a set of actions that can be taken on the list as a whole. For instance, when the user actuates the list actions actuator, component 194 can display a set of actuators in a pop-up menu. When the user actuates one of them, performance component 144 performs a corresponding action on the list. Displaying the list actions actuator is indicated by block 248 in FIG. 3.

The visualization can include other items 250 as well. Once the visualization is generated, visualization system 118 controls user interface component 118 to surface the visualization as a user interface display on phone display mechanism 104. This is indicated by block 252 in the flow diagram of FIG. 3.

At some point, as indicated by block 254, the user may actuate a user actuatable element on the user interface display. When this happens, performance component 144 performs an action corresponding to the actuated element. This is indicated by block 246. For instance, it may be that the user provides a scroll input to scroll the vertical panel. This is indicated by block 258. The user may tap on or otherwise actuate one of the bricks. In that case, performance component 144 illustratively shows row details and row actions corresponding to the actuated brick. This is indicated by block 260. The user may also navigate to a details page view for a given row, or for another element, or otherwise navigate on the user interface visualization. This is indicated by block 261. User interaction detector 142 can detect other user interactions, and other actions can be performed. This is indicated by block 262.

FIG. 3A illustrates one example of a transformation from a tablet list page display 270 to a set of phone list page displays 272 and 274. The tablet list view display 270 illustratively includes a set of constituents, such as a grid with rows divided into columns, each row representing an entity or other list item. FIG. 3A shows the grid as a vertically scrollable list of rows 276. The grid may have horizontal scroll bars as well. Any actions available to the user that operate on a specific row (e.g., row actions which may include such things as “delete”, etc.) are shown by actuating a row actions display element 278. When the user does this, a pop-up menu is displayed with a set of user actuatable mechanisms, each corresponding to a row action. When the user actuates one of those mechanisms, that action is performed on the row.

Any action available to the user that operates on the entire list (such as export to a spreadsheet, etc.) is referred to as a list action. A list action actuator 280 is provided on an upper portion of the list page. When the user actuates it, a pop-up menu is displayed with user actuatable elements, each corresponding to a list action. When the user actuates one of those elements, that list action is performed on the list, as a whole.

In order to transform the tablet list page display 270 to the phone list page display 272 or 274, constituent element identifier 134 illustratively identifies all of the elements on the list page display 270 for the tablet, based upon the list page metadata. List page transformation component 138 then transforms those constituent elements into the list page displays 272 and 274.

For instance, in one example, this is done in a sequence of transformation and display steps. In a first step, transformation component 138 shows a vertically scrollable list, where each row is represented by a brick. The brick may be pre-defined, such as by the application developer or otherwise, as a subset of data from the corresponding list row. The list of bricks is shown at 282 in FIG. 3A. Then, when the user interacts with one of the bricks (such as by tapping it or otherwise actuating it), this is detected by user interaction detector 142. Performance component 144 then uses list page transformation component 138 to navigate the user to the next step in the sequence, where the brick is expanded to show all data from the row corresponding to the actuated brick. The row detail is indicated by block 284 in FIG. 3A.

FIG. 3A also shows that, in one example, when the user is viewing the list of bricks 282, a list actions actuator 284 is shown. Actuator 284 corresponds to list actions actuator 280 on tablet display 270. When the user actuates actuator 284, a pop-up menu is displayed with list action elements. The user can actuate one of those elements to perform a list action on the list, as a whole. Similarly, when the user is viewing the row details 284, row actions actuator 286 is displayed. Actuator 286 corresponds to actuator 278 on the tablet display 270. Thus, when the user actuates actuator 286, a pop-up display can be displayed with actuatable elements corresponding to row actions that can be performed on the row.

FIG. 3B shows one more detailed example of tablet display 270. Some of the items on tablet display 270 are similar to those shown in FIG. 3A, and they are similarly numbered. Thus, the grid of rows divided into columns is shown generally at 276. The list actions actuator 280 is also illustrated, as is the row actions actuator 278. In one example, there is a row actions actuator 278 for each row in grid structure 276. FIG. 3B shows that the user has actuated actuator 278. Therefore, pop-up menu 290 is shown with a set of user actuatable display elements 292, each corresponding to a row action. That is, the user can perform actions on the individual row corresponding to actuator 278.

FIG. 3C is similar to that shown in FIG. 3B, and similar items are similarly numbered. However, FIG. 3C now shows that the user has actuated the list actions actuator 280. Therefore, pop-up menu 294 is displayed with a set of user actuatable elements 296. Each element corresponds to a list action that can be performed on the list, as a whole.

FIG. 3D shows one example of phone user interface display 272 that was generated from the list display 270 shown on the tablet in FIGS. 3B-3C. Some items are similar to those shown in FIG. 3A and they are similarly numbered. It can be seen that the list of bricks 282 is shown. Each brick illustratively includes a customer name and a contact, and a set of metrics that may be made available. Again, the bricks can be preconfigured by the application developer or otherwise, to include a pre-defined set of information. FIG. 3D shows that the list actions actuator 284 is disposed in the lower right hand corner of the display.

FIG. 3E shows one example of a phone user interface display that can be generated when the user actuates list actions actuator 284. It can be seen that pop-up menu 300 is displayed with a set of actuatable mechanisms 302. Each mechanism 302 corresponds to a list action that can be performed on the list as a whole.

FIG. 3F shows one example of the user interface display 274 (also shown in FIG. 3A), where the user has actuated a brick 282 corresponding to “Furnishing Co.”. In that case, the row details 285 are displayed for the row corresponding to that particular brick. When the row details display 285 is being displayed, the row actions actuator 286 is displayed instead of list actions actuator 284. Thus, when the user actuates actuator 286, a pop-up menu is displayed showing actions that can be performed on the particular row for which details are being displayed.

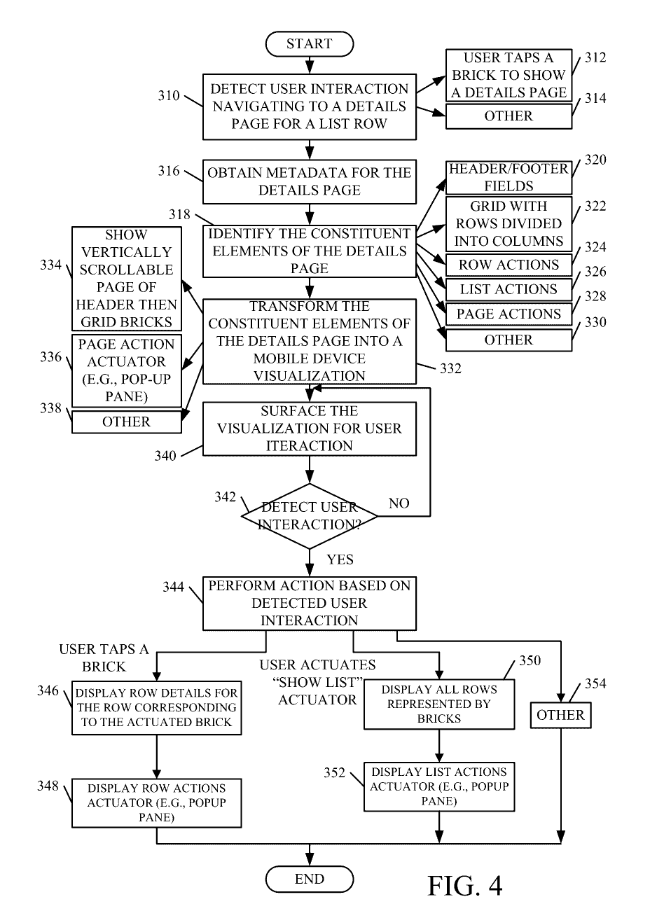

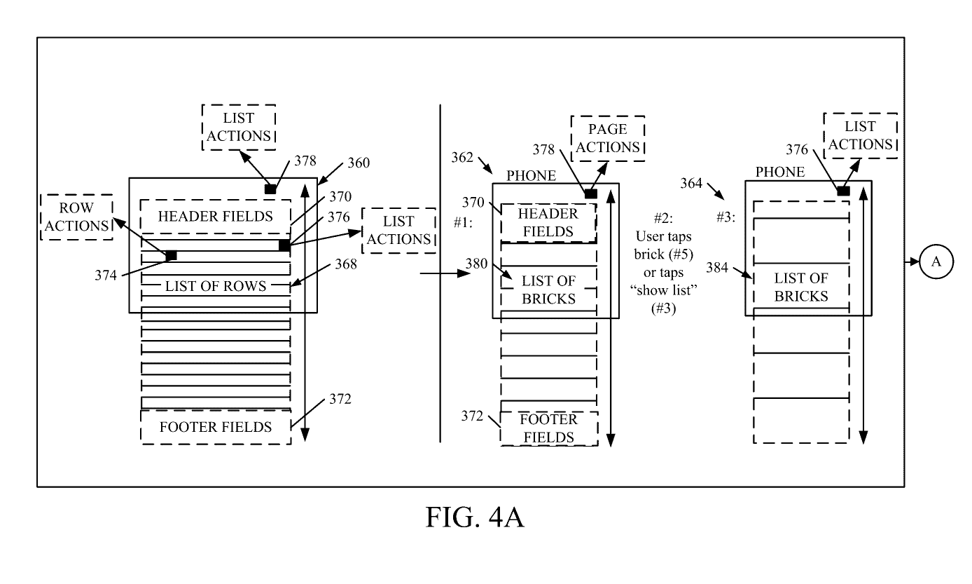

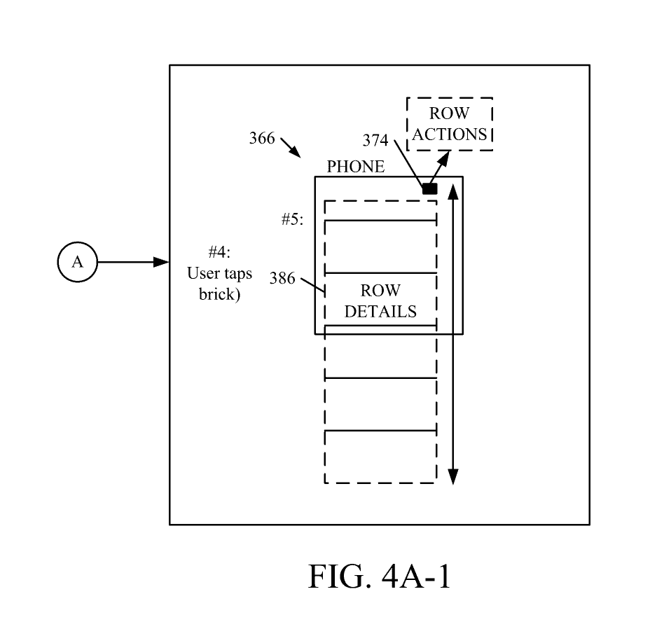

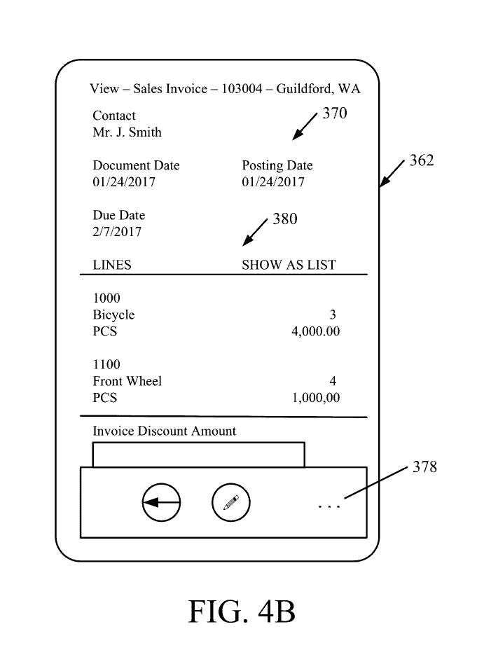

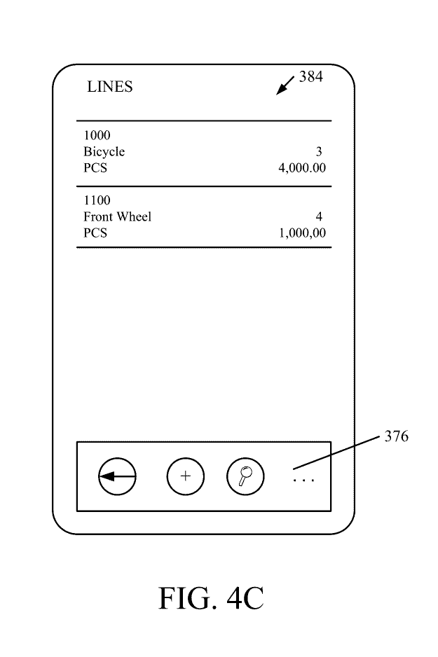

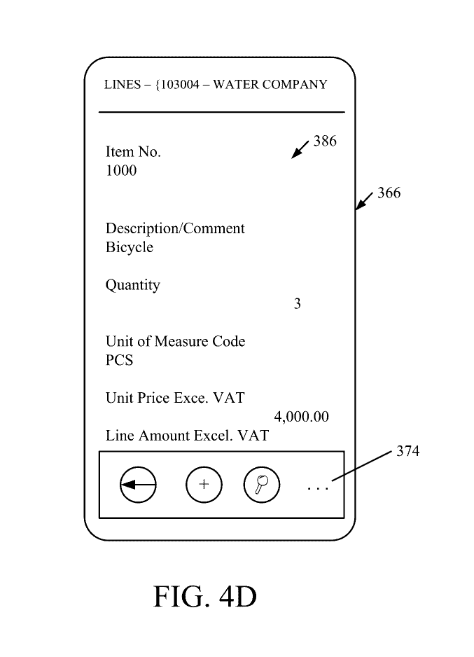

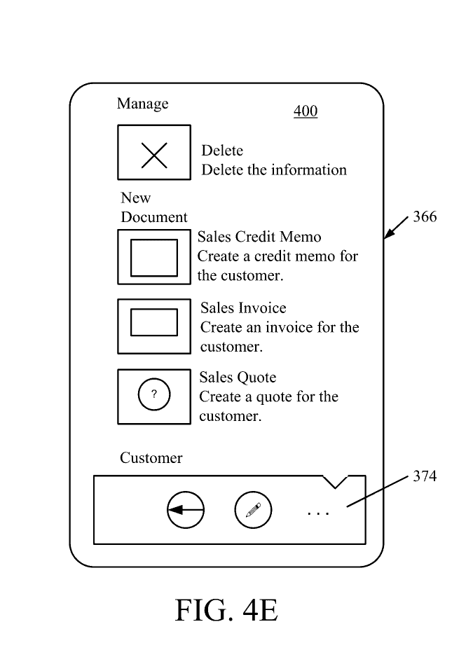

FIG. 4 is a flow diagram illustrating one example of the operation of visualization system 118 in generating a details page display. User interaction detector 142 first detects that the user has provided an interaction navigating to a details page for an item, such as a list row. This is indicated by block 210 in FIG. 4. For instance, the user may tap a brick on a previous page, to show a details page. This is indicated by block 312. The user can navigate to a details page in other ways as well, and this is indicated by block 314.

Constituent element identifier 134 then accesses the metadata 130 for the details page and identifies the constituent elements of the details page. This is indicated by blocks 316 and 318 in FIG. 4. The constituent elements may include, for instance, header and footer fields 320, a grid with rows divided into columns as indicated by block 322, a row actions actuator 324, list actions actuator 326, a page actions actuator 328, and a variety of other things 330.

Details page transformation component 140 then transforms the constituent elements of the details page into a phone visualization. This is indicated by block 332. In one example, it can show a vertically scrollable page of header information and then a grid of bricks. This is indicated by block 334. The bricks each represent a row (and bricks corresponding to a subset of the rows may be displayed). A brick, as discussed above, may be pre-defined by an application developer in advance, or otherwise. The brick illustratively displays a subset of data from the row and may include specific data that identifies the row sufficiently to a user. The display can also illustratively include a page action actuator as indicated by block 336. As with the other action actuators, this may be an actuator that, when actuated, displays a pop-up menu with actuatable elements, each element corresponding to a page action that can be performed on the page, as a whole. The details page visualization can include other items 338 as well.

Visualization system 118 then controls user interface component 114 to surface the visualization for user interaction. This is indicated by block 340.

At some point, a user may interact with the display, such as by tapping one of the user actuatable bricks, or otherwise. This is indicated by block 342. When this happens, performance component 144 illustratively performs an action based on the detected user interaction. This is indicated by block 344. For instance, when the user taps a brick, performance component 144 displays row details for the row corresponding to the actuated brick. This is indicated by block 346. It also illustratively displays a row actions actuator as indicated by block 348. The user can actuate the actuator 348 and a pop-up menu is illustratively displayed with user actuatable elements, each corresponding to a row action.

When the list view visualization is displayed, the user may also provide an input indicating that the user wishes to see the list, itself. In that case, component 144 displays all rows, represented by bricks, in a vertically scrollable display. This is indicated by block 350. It also illustratively displays a list actions actuator as indicated by block 352. Other user interactions can be detected as well, and this is indicated by block 354.

FIGS. 4A and 4A-1 (collectively referred to as FIG. 4A) show a diagram illustrating how a details tablet user interface display shown generally at 360 is transformed into a set of phone list detail visualizations 362, 364, and 366. The tablet display 360 illustratively includes the grid which is shown generally at 368. Header fields 370 and footer fields 372 are shown at the top and bottom of the grid 368. A row action actuator 374 is associated with each row, and a list action actuator 376 is associated with the list of rows (e.g., the grid). A page action actuator 378 is also displayed on the page so that actions can be taken with respect to the page, as a whole.

FIG. 4A also shows that, in one example, details page transformation component 138 transforms the display 360 into displays 362-366. For instance, the initial details page display 362 is a vertically scrollable display with header fields 370 displayed at the top, and footer fields 372 displayed at the bottom. The page actions actuator 378 is also shown on display 362. Instead of a list of rows, however, the transformation displays a list of bricks 380 between the header and footer fields. As discussed above, the set of bricks may contain information from a relatively small subset of rows. Each brick thus includes summary or other representative data from a corresponding row or from an aggregated group of rows.

When the user provides an input indicating that the user wishes to view the list, from display 362, then display 364 is generated. Display 364 includes a full list of bricks 384. The full list of bricks includes a brick corresponding to each row in the list. Also, the list actions actuator 376 is shown on the visualization.

When the user taps or otherwise actuates one of the bricks shown in either display 362 or 364, then performance component 144 illustratively shows a row details display such as display 366. Row details 386 are displayed, for the particular row corresponding to the brick that the user actuated. In addition, when viewing display 366, the row actions actuator 374 corresponding to the row for which details are being viewed, is also displayed.

FIGS. 4B-4E show specific examples of user interface displays that can be displayed. Some elements of FIGS. 4B-4E are similar to those shown in FIG. 4A and are similarly numbered. FIG. 4B, for instance, shows one example of user interface display 362. It can be seen that a set of header fields 370 is shown on the display. A set of bricks 380 are also shown. Each brick corresponds to a row in a list and contains some identifying information for that row. Also, the page actions actuator 378 is also displayed.

If, on the user interface display 362 shown in FIG. 4B, the user provides an input indicating that the user wishes to view the list, then any header and footer fields are removed, and a full list of bricks is displayed with one brick corresponding to each line item or row in the list. FIG. 4C shows one example of this. In addition to showing the full list of bricks 384, the list actions actuator 376 is displayed so that the user can take actions on the list.

When the user actuates one of the bricks in the list of bricks 384, the user is then navigated to the row details display 366. FIG. 4D shows one example of this. It can be seen in FIG. 4D that the user has actuated the “Bicycle” brick 384 in FIG. 4C. Thus, the row details for the corresponding list row are displayed in FIG. 4D. Further, the row actions actuator 374 is also displayed so that the user can take actions on the row. FIG. 4E shows one example of a pop-up display 400 that can be displayed when the user actuates the row actions actuator 374.

It can thus be seen that, by identifying constituent elements of a display (which may be identified in metadata for that display), those constituent elements can be displayed in a sensible way on a user interface display of a much smaller device, such as a phone display. Further, the various actions that can be taken relative to the various displays can be enabled by displaying actuators, in context. Thus, when row details are being displayed, the row actions actuator is displayed. When a list page is being displayed, then the list actions actuator is displayed. When the start page or another overall page is being displayed, then the page actions actuator can be displayed to take actions on the page, as a whole. This saves display real estate and also increases the efficiency of both the user and the rendering overhead.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

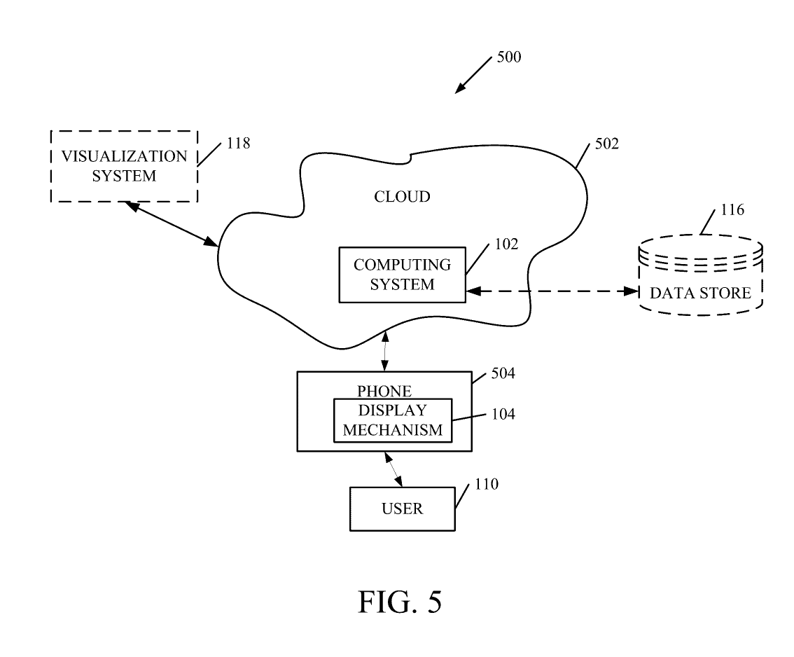

FIG. 5 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 5, some items are similar to those shown in FIG. 1 and they are similarly numbered. FIG. 5 specifically shows that computing system 102 can be located in cloud 502 (which can be public, private, or a combination where portions are public while others are private). Therefore, user 110 uses phone 504 to access those systems through cloud 502.

FIG. 5 also depicts another example of a cloud architecture. FIG. 5 shows that it is also contemplated that some elements of architecture 100 can be disposed in cloud 502 while others are not. By way of example, data store 116 can be disposed outside of cloud 502, and accessed through cloud 502. In another example, visualization system 118 can also be outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

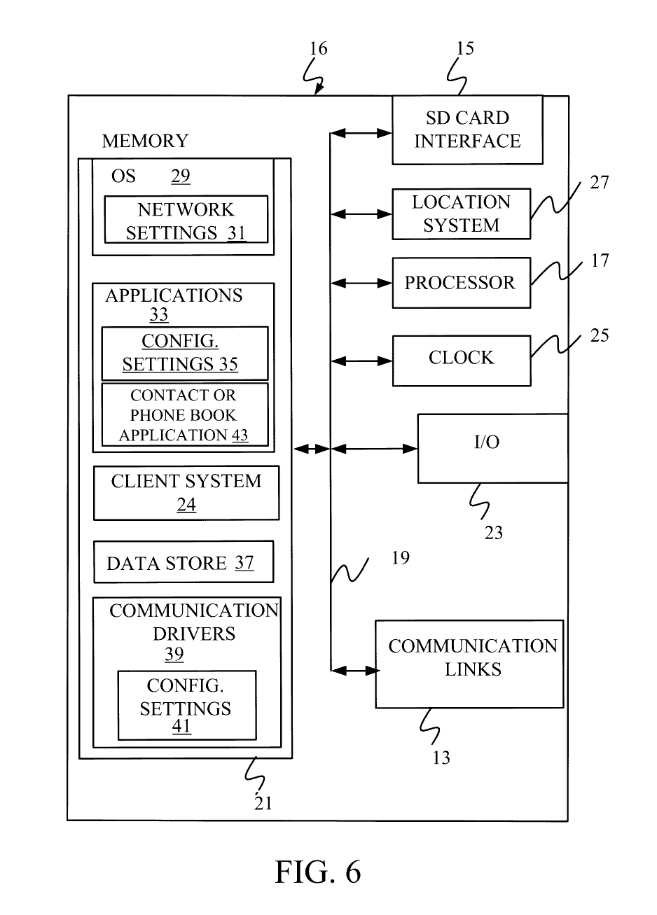

FIG. 6 is a simplified block diagram of one illustrative example of a handheld or phone computing device that can be used as a user's or client's hand held device 16, in which the present system (or parts of it) can be deployed.

FIG. 6 provides a general block diagram of the components of a client device 16 that can run components of architecture 100 or that interacts with architecture 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as Wi-Fi protocols, and Bluetooth protocol, which provide local wireless connections to networks.

In other example, applications or systems are received on a removable Secure Digital (SD) card that is connected to a SD card interface 15. SD card interface 15 and communication links 13 communicate with a processor 17 (which can also embody processors 112 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client system 24 which can run various business applications or embody parts or all of architecture 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

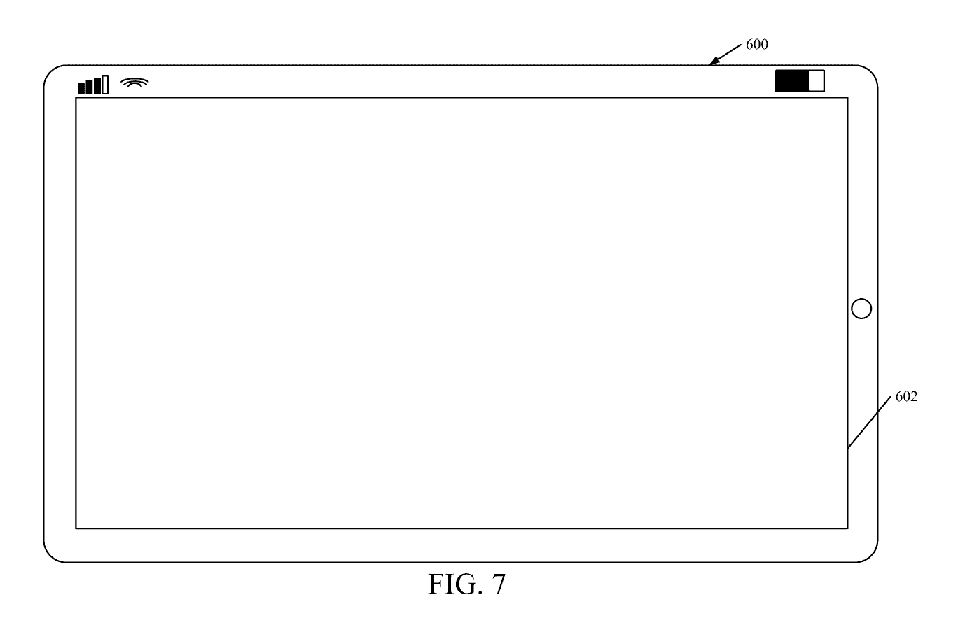

FIG. 7 shows one example of a tablet computer 600. In FIG. 6, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

Additional examples of devices 16 can be used as well. Device 16 can be, a feature phone, smart phone or mobile phone. The phone can include a set of keypads for dialing phone numbers, a display capable of displaying images including application images, icons, web pages, photographs, and video, and control buttons for selecting items shown on the display. The phone can include an antenna for receiving cellular phone signals such as General Packet Radio Service (GPRS) and 1×rtt, and Short Message Service (SMS) signals. In some examples the phone also includes a Secure Digital (SD) card slot that accepts a SD card.

The mobile device can also be a personal digital assistant or a multimedia player or a tablet computing device, etc. (hereinafter referred to as a PDA). The PDA can include an inductive screen that senses the position of a stylus (or other pointers, such as a user's finger) when the stylus is positioned over the screen. This allows the user to select, highlight, and move items on the screen as well as draw and write. The PDA can also include a number of user input keys or buttons which allow the user to scroll through menu options or other display options which are displayed on the display, and allow the user to change applications or select user input functions, without contacting the display. The PDA can also include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections.

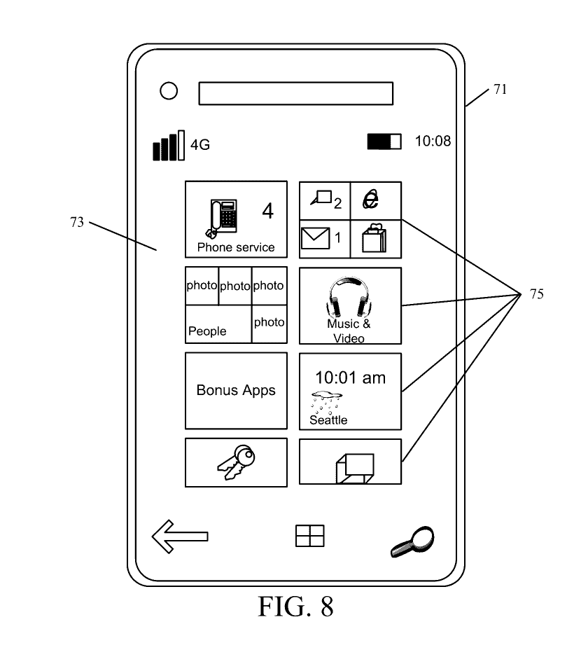

FIG. 8 is one example of a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

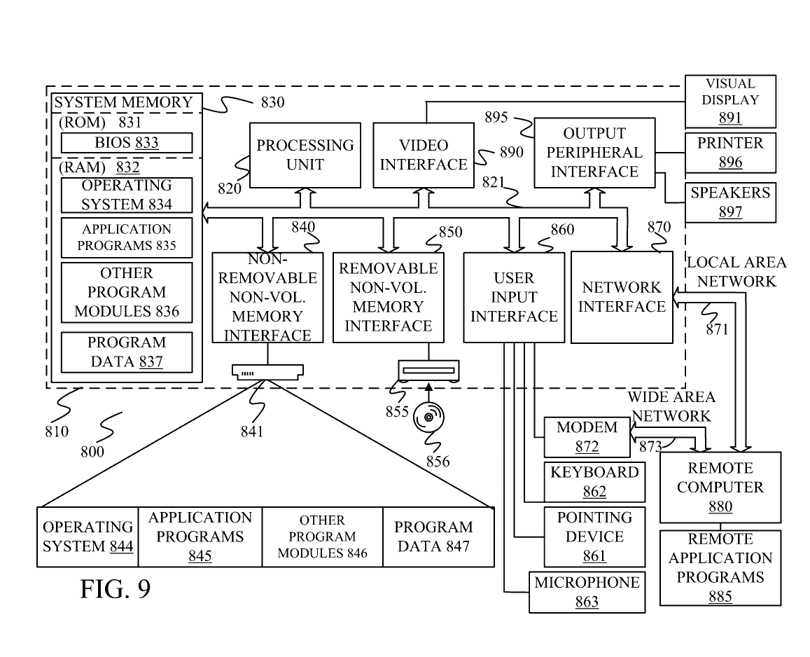

FIG. 9 is one example of a computing environment in which architecture 100, or parts of it, (for example) can be deployed. With reference to FIG. 9, an example system for implementing some embodiments includes a general-purpose computing device in the form of a computer 810. Components of computer 810 may include, but are not limited to, a processing unit 820 (which can comprise processors or servers 112), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 9.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 9 illustrates operating system 834, application programs 835, other program modules 836, and program data 837.

The computer 810 may also include other removable/non-removable volatile/nonvolatile computer storage media. By way of example only, FIG. 9 illustrates a hard disk drive 841 that reads from or writes to non-removable, nonvolatile magnetic media, an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 9, provide storage of computer readable instructions, data structures, program modules and other data for the computer 810. In FIG. 9, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 9 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 9 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a computing system, comprising:

a user interface component that detects a user interaction requesting a page display on a phone display mechanism;

a constituent element identifier that accesses a page display definition for the page display, that defines the page display, and identifies constituent elements of the page display, from the page display definition; and

a page transformation component that transforms the page display definition into a phone display definition for the page display, the user interface component controlling the phone display mechanism to display the page display according to the phone display definition.

Example 2 is the computing system of any or all previous claims wherein the constituent element identifier identifies constituent elements to include action actuators that are actuatable to perform actions on displayed constituent elements.

Example 3 is the computing system of any or all previous claims wherein the page transformation component generates the phone display definition to selectively display the action actuators on the phone display based on a display context of the phone display.

Example 4 is the computing system of any or all previous claims wherein the action actuators comprise page actuators that are actuatable to perform an action on a page, list action actuators that are actuatable to perform an action on a list and row actuators that are actuatable to perform an action on a row in a list, and wherein the page transformation component generates the phone display definition to display the page action actuators when the page display is an overall page display, the list action actuators when the page display is a list page display and the row action actuators when the page display is a row details display.

Example 5 is the computing system of any or all previous claims wherein the page display definition comprises a definition for displaying the page display on a larger form factor device that has a larger display mechanism than the phone display mechanism.

Example 6 is the computing system of any or all previous claims wherein the page display definition comprises a definition for displaying the page display on a tablet computing device.

Example 7 is the computing system of claim 6 wherein the page display comprises a start page display, the constituent element identifier identifying the constituent elements of the start page display as including a list actuator section, an actions actuator section, a metrics section and a plurality of part sections.

Example 8 is the computing system of any or all previous claims wherein the page transformation component comprises:

a start page transformation component that generates the phone display as a horizontally scrollable display with the list actuator section on a far left of the horizontally scrollable display, and the actions actuator section on a far right of the horizontally scrollable display.

Example 9 is the computing system of any or all previous claims wherein the start page transformation component generates the phone display with the metrics section left of the plurality of part sections on the horizontally scrollable display.

Example 10 is the computing system of any or all previous claims wherein the start page transformation component controls the user interface component to automatically scroll the horizontally scrollable display to the metrics section.

Example 11 is the computing system of claim 6 wherein the page display comprises a list page display, the constituent element identifier identifying the constituent elements of the list page display as including a list actions actuator section, a row actions actuator section, and a grid section with rows divided into columns.

Example 12 is the computing system of any or all previous claims wherein the page transformation component comprises:

a list page transformation component that generates the phone display with a fixed list actions actuator and a vertically scrollable list of user actuatable brick display elements, each brick display element displaying a subset of information from a corresponding row in the grid section.

Example 13 is the computing system of any or all previous claims and further comprising:

a user interaction detector that detects user interaction with a given brick display element; and

a performance component that navigates to a row details display that shows row details for the row corresponding to the given brick display element, and that displays a row actions actuator that is actuatable to perform an action on the row.

Example 14 is the computing system of any or all previous claims wherein the page display comprises a details page display, the constituent element identifier identifying the constituent elements of the details page display as including a page actions actuator section, a list actions actuator section, a row actions actuator section, a header section, a grid section with rows divided into columns, and a footer section.

Example 15 is the computing system of any or all previous claims wherein the page transformation component comprises:

a details page transformation component that generates the phone display with a fixed page actions actuator and a vertically scrollable list of user actuatable brick display elements, bracketed by header and footer display sections, the brick display elements corresponding to a subset of rows in the grid display section and each brick display element displaying a subset of information from a corresponding row in the grid section.

Example 16 is the computing system of any or all previous claims and further comprising:

a user interaction detector that detects a user interaction either with a given brick display element or with a show list action actuator; and

a performance component that:

in response to the user interacting with a given brick display element, navigates to a row details display that shows row details for the row corresponding to the given brick display element, and that displays a row actions actuator that is actuatable to perform an action on the row; and

in response to the user interacting with the show list action actuator, displays a vertically scrollable display of brick display elements corresponding to the full set of rows in the grid display section, and that displays the list actions actuator that is actuatable to perform an action on the list.

Example 17 is a computer implemented method, comprising:

detecting a user interaction requesting a page display on a phone display mechanism;

accessing a page display definition for the page display, that defines the page display;

identifying constituent elements of the page display, from the page display definition, the constituent elements including action actuators that are actuatable to perform actions on displayed constituent elements;

transforming the page display definition into a phone display definition for the page display, by generating the phone display definition to selectively display the action actuators on the phone display based on a display context of the phone display; and

controlling the phone display mechanism to display the page display according to the phone display definition.

Example 18 is the computer implemented method of any or all previous claims wherein the action actuators comprise page actuators that are actuatable to perform an action on a page, list action actuators that are actuatable to perform an action on a list and row actuators that are actuatable to perform an action on a row in a list, and wherein transforming comprises:

generating the phone display definition to display the page action actuators when the page display is an overall page display, the list action actuators when the page display is a list page display and the row action actuators when the page display is a row details display.

Example 19 is a computing system, comprising:

a user interface component that detects a user interaction requesting a page display on a phone display mechanism;

a constituent element identifier that accesses a tablet page display definition for the page display, that defines the page display on a tablet computing device, and identifies constituent elements of the page display, from the page display definition, the constituent elements including action actuators that are actuatable to perform actions on displayed constituent elements; and

a page transformation component that transforms the tablet page display definition into a phone display definition for the page display, the user interface component controlling the phone display mechanism to display the page display according to the phone display definition, the page transformation component generating the phone display definition to selectively display the action actuators on the phone display based on a display context of the phone display.

Example 20 is the computer implemented method of any or all previous claims wherein the action actuators comprise page actuators that are actuatable to perform an action on a page, list action actuators that are actuatable to perform an action on a list and row actuators that are actuatable to perform an action on a row in a list, and wherein the page transformation component generates the phone display definition to display the page action actuators when the page display is an overall page display, the list action actuators when the page display is a list page display and the row action actuators when the page display is a row details display.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing system, comprising:
a user interface component that detects a user interaction requesting a page display on a phone display mechanism;
a constituent element identifier that accesses a page display definition for the page display, that defines the page display, and identifies constituent elements of the page display, from the page display definition; and
a page transformation component that transforms the page display definition into a phone display definition for the page display, the user interface component controlling the phone display mechanism to display the page display according to the phone display definition.

2. The computing system of claim 1 wherein the constituent element identifier identifies constituent elements to include action actuators that are actuatable to perform actions on displayed constituent elements.

3. The computing system of claim 2 wherein the page transformation component generates the phone display definition to selectively display the action actuators on the phone display based on a display context of the phone display.

4. The computing system of claim 3 wherein the action actuators comprise page actuators that are actuatable to perform an action on a page, list action actuators that are actuatable to perform an action on a list and row actuators that are actuatable to perform an action on a row in a list, and wherein the page transformation component generates the phone display definition to display the page action actuators when the page display is an overall page display, the list action actuators when the page display is a list page display and the row action actuators when the page display is a row details display.

5. The computing system of claim 1 wherein the page display definition comprises a definition for displaying the page display on a larger form factor device that has a larger display mechanism than the phone display mechanism.

6. The computing system of claim 5 wherein the page display definition comprises a definition for displaying the page display on a tablet computing device.

7. The computing system of claim 6 wherein the page display comprises a start page display, the constituent element identifier identifying the constituent elements of the start page display as including a list actuator section, an actions actuator section, a metrics section and a plurality of part sections.

8. The computing system of claim 7 wherein the page transformation component comprises:
a start page transformation component that generates the phone display as a horizontally scrollable display with the list actuator section on a far left of the horizontally scrollable display, and the actions actuator section on a far right of the horizontally scrollable display.

9. The computing system of claim 8 wherein the start page transformation component generates the phone display with the metrics section left of the plurality of part sections on the horizontally scrollable display.

10. The computing system of claim 9 wherein the start page transformation component controls the user interface component to automatically scroll the horizontally scrollable display to the metrics section.

11. The computing system of claim 6 wherein the page display comprises a list page display, the constituent element identifier identifying the constituent elements of the list page display as including a list actions actuator section, a row actions actuator section, and a grid section with rows divided into columns.

12. The computing system of claim 11 wherein the page transformation component comprises:
a list page transformation component that generates the phone display with a fixed list actions actuator and a vertically scrollable list of user actuatable brick display elements, each brick display element displaying a subset of information from a corresponding row in the grid section.

13. The computing system of claim 12 and further comprising:
a user interaction detector that detects user interaction with a given brick display element; and
a performance component that navigates to a row details display that shows row details for the row corresponding to the given brick display element, and that displays a row actions actuator that is actuatable to perform an action on the row.

14. The computing system of claim 6 wherein the page display comprises a details page display, the constituent element identifier identifying the constituent elements of the details page display as including a page actions actuator section, a list actions actuator section, a row actions actuator section, a header section, a grid section with rows divided into columns, and a footer section.

15. The computing system of claim 14 wherein the page transformation component comprises:
a details page transformation component that generates the phone display with a fixed page actions actuator and a vertically scrollable list of user actuatable brick display elements, bracketed by header and footer display sections, the brick display elements corresponding to a subset of rows in the grid display section and each brick display element displaying a subset of information from a corresponding row in the grid section.

16. The computing system of claim 15 and further comprising:
a user interaction detector that detects a user interaction either with a given brick display element or with a show list action actuator; and
a performance component that:
in response to the user interacting with a given brick display element, navigates to a row details display that shows row details for the row corresponding to the given brick display element, and that displays a row actions actuator that is actuatable to perform an action on the row; and
in response to the user interacting with the show list action actuator, displays a vertically scrollable display of brick display elements corresponding to the full set of rows in the grid display section, and that displays the list actions actuator that is actuatable to perform an action on the list.

17. A computer implemented method, comprising:
detecting a user interaction requesting a page display on a phone display mechanism;
accessing a page display definition for the page display, that defines the page display;
identifying constituent elements of the page display, from the page display definition, the constituent elements including action actuators that are actuatable to perform actions on displayed constituent elements;
transforming the page display definition into a phone display definition for the page display, by generating the phone display definition to selectively display the action actuators on the phone display based on a display context of the phone display; and
controlling the phone display mechanism to display the page display according to the phone display definition.

18. The computer implemented method of claim 17 wherein the action actuators comprise page actuators that are actuatable to perform an action on a page, list action actuators that are actuatable to perform an action on a list and row actuators that are actuatable to perform an action on a row in a list, and wherein transforming comprises:
generating the phone display definition to display the page action actuators when the page display is an overall page display, the list action actuators when the page display is a list page display and the row action actuators when the page display is a row details display.

19. A computing system, comprising:
a user interface component that detects a user interaction requesting a page display on a phone display mechanism;
a constituent element identifier that accesses a tablet page display definition for the page display, that defines the page display on a tablet computing device, and identifies constituent elements of the page display, from the page display definition, the constituent elements including action actuators that are actuatable to perform actions on displayed constituent elements; and
a page transformation component that transforms the tablet page display definition into a phone display definition for the page display, the user interface component controlling the phone display mechanism to display the page display according to the phone display definition, the page transformation component generating the phone display definition to selectively display the action actuators on the phone display based on a display context of the phone display.

20. The computer implemented method of claim 19 wherein the action actuators comprise page actuators that are actuatable to perform an action on a page, list action actuators that are actuatable to perform an action on a list and row actuators that are actuatable to perform an action on a row in a list, and wherein the page transformation component generates the phone display definition to display the page action actuators when the page display is an overall page display, the list action actuators when the page display is a list page display and the row action actuators when the page display is a row details display.
